(19) United States
(12) Patent Application Publication
(10) Pub. No.: US 2024/0330399 A1
(43) Pub. Date: Oct. 3, 2024

(54) NEURAL NETWORK INCLUDING LOCAL STORAGE UNIT

(71) Applicant: STMicroelectronics International N.V., Geneva (CH)

(72) Inventors: Carmine CAPPETTA, Battipaglia (IT); Surinder Pal SINGH, NOIDA (IN); Giuseppe DESOLI, San Fermo Della Battaglia (IT); Thomas BOESCH, Rovio (CH)

(73) Assignee: STMicroelectronics International N.V., Geneva (CH)

(21) Appl. No.: 18/194,108

(22) Filed: Mar. 31, 2023

(51) Int. Cl. G06F 17/15

(52) U.S. Cl. CPC G06F 17/15

(57) ABSTRACT

A neural network includes an internal storage unit. The internal storage unit stores feature data received from a memory external to the neural network. The internal storage unit reads the feature data to a hardware accelerator of the neural network. The internal storage unit adapts a storage pattern of the feature data and a read pattern of the feature data to enhance the efficiency of the hardware accelerator.

### BACKGROUND

### Technical Field

The present disclosure generally relates to neural networks, and more particularly to convolutional neural networks (CNNs).

### Description of the Related Art

Deep learning algorithms promote very high performance in numerous applications involving recognition, identification and/or classification tasks, however, such advancements may come at the price of significant usage of processing power. Thus, their adoption can be hindered by a lack of availability of low-cost and energy-efficient solutions. Accordingly, severe performance specifications may coexist with tight constraints in terms of power and energy consumption while deploying deep learning applications on embedded devices.

CNNs are a type of Deep Neural Networks (DNN). Their architecture is characterized by Convolutional Layers and Fully Connected Layers. The former layers carry on convolution operations between layer's inputs and convolutional kernels, non-linear activation functions (such as rectifiers) and max pooling operations, which are usually the most demanding ones in terms of computational effort.

### BRIEF SUMMARY

In one embodiment, a method includes receiving, at a neural network, feature data from a memory external to the neural network, passing the feature data to an internal storage of the neural network, and storing, with a write transformation unit of the internal storage, the feature data in the internal storage with a first address configuration based on a first hardware accelerator that is next in a flow of the neural network. The method includes passing the feature data from the internal storage to the first hardware accelerator and generating first transformed feature data by processing the feature data with the first hardware accelerator.

In one embodiment, a method includes receiving, at a neural network, feature data from a memory external to the neural network and passing the feature data to an internal storage of the neural network. The method includes storing the feature data in the internal storage and reading, with a read transformation unit of the neural network, the feature data to a first hardware accelerator with a read address pattern based on an operation of the first hardware accelerator. The method includes generating first transformed feature data by processing the feature data with the first hardware accelerator.

In one embodiment, a device includes a neural network. The neural network includes a stream engine configured to receive feature data from a memory external to the neural network, a hardware accelerator, and an internal storage configured to receive the feature data from the stream engine. The internal storage includes a write transformation unit configured to write the feature data into the internal storage with a write address pattern based on a configuration of the hardware accelerator. The internal storage includes a read transformation unit configured to read the feature data to the hardware accelerator with a read address pattern based on the configuration of the hardware accelerator, the hardware accelerator configured to receive the feature data from the internal storage, to process the feature data to generate transformed feature data.

### BRIEF DESCRIPTION OF THE SEVERAL VIEWS OF THE DRAWINGS

FIG. 1 is a block diagram of an electronic device, according to some embodiments.

FIG. 2 is a block diagram of process flow within a neural network, according to some embodiments.

FIG. 3 is a block diagram of a portion of a neural network, according to some embodiments

FIG. 4 is a representation of a feature tensor, according to some embodiments.

FIG. 5 is a representation of a feature tensor and sub-tensors extracted from the feature tensor, according to some embodiments.

FIG. 6 is a representation of a feature tensor and sub-tensors extracted from the feature tensor, according to some embodiments.

FIG. 7 is a block diagram of an internal storage of a neural network, according to some embodiments.

FIG. 8 is an illustration of memory being read from an internal storage of a neural network, according to some embodiments

FIG. 9 is an illustration of memory being read from an internal storage of a neural network, according to some embodiments.

FIG. 10 is flow diagram of method for operating a CNN, according to some embodiments.

FIG. 11 is flow diagram of method for operating a CNN, according to some embodiments.

### DETAILED DESCRIPTION

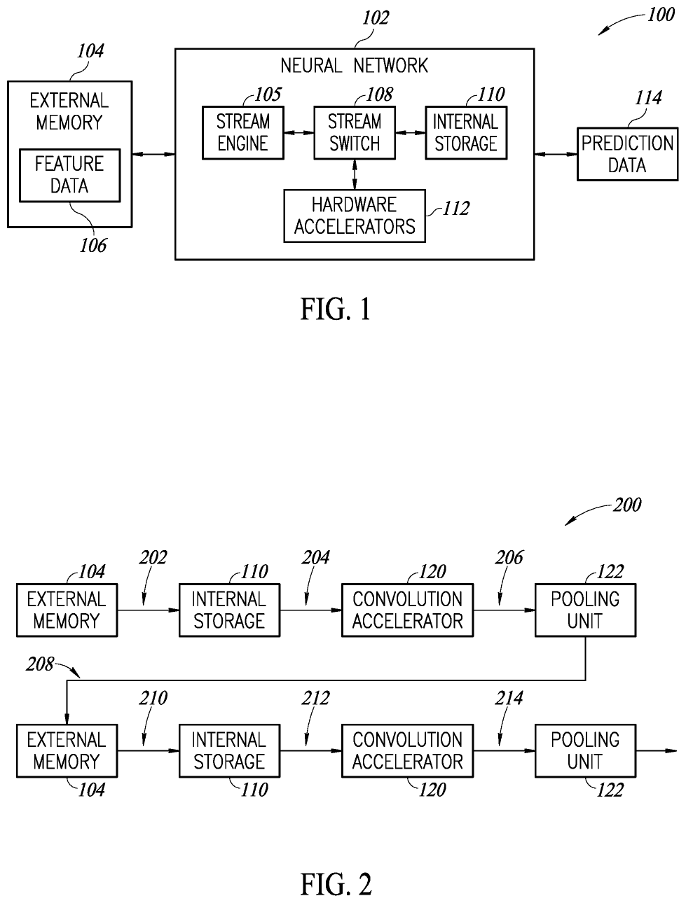

FIG. 1 is a block diagram of an electronic device 100, according to some embodiments. The electronic device 100 includes a neural network 102 and an external memory 104. The external memory 104 includes feature data 106 for processing by the neural network 102. The neural network 102 receives the feature data 106 from the external memory 104 and generates prediction data 114 based on the feature data 106. As will be set forth in more detail below, the components of the neural network 102 cooperate to provide effective and efficient processing of feature data 106.

In a neural network, feature data may be read multiple times from an external memory. However, reading data from the external memory be utilized large amounts of time and processing resources. The neural network 102 provides increased efficiency by including an internal storage 110. As will be set forth in more detail below, the internal storage 110 greatly enhances the efficiency of the neural network 102 by reducing a number of times that the neural network 102 reads from the external memory 104.

In one embodiment, the feature data 106 is generated by an image sensor (not shown) or another type of sensor of the electronic device 100. Accordingly, the feature data 106 can include image data corresponding to one or more images captured by the image sensor. The image data is formatted so that it can be received by the neural network 102. The neural network 102 analyzes the feature data 106 and generates the prediction data 114. The prediction data 114 indicates a prediction or classification related to one or more aspects of the image data. The prediction data 114 can correspond to recognizing shapes, objects, faces, or other aspects of an image. While some embodiments herein describe that feature data 106 is received from a sensor or sensor system, the feature data 106 can be received from other types of systems or devices without departing from the scope of the present disclosure. For example, the feature data 106 may include a data structure stored in a memory and containing statistical data collected and stored by an external CPU. Other types of feature data 106 can be utilized without departing from the scope of the present disclosure. The components of the neural network 102 may be implemented on a single integrated circuit die as an application specific integrated circuit (ASIC).

While some examples herein describe a neural network 102 implemented in conjunction with an image sensor, the neural network 102 may be implemented in conjunction with other types of sensors without departing from the scope of the present disclosure, or various combinations of types of sensors. Additionally, the neural network 102 may process data other than sensor data without departing from the scope of the present disclosure. Furthermore, machine learning networks or processes other than neural networks can be utilized without departing from the scope of the present disclosure.

In one embodiment, the neural network 102 is trained with a machine learning process to recognize aspects of training images that are provided to the neural network 102. The machine learning process includes passing a plurality of training images with known features to the neural network 102. The machine learning process trains the neural network 102 to generate prediction data that accurately predicts or classifies the features of the training images. The training process can include a deep learning process.

The neural network 102 includes a plurality of hardware accelerators 112. The hardware accelerators correspond to hardware circuits that collectively perform the function of the neural network 102. The hardware accelerators 112 can include convolution units, activation units, pooling units, multiply and accumulate (MAC) units, decompression units, and other types of units.

In the example of a convolutional neural network, the convolution units implement convolution layers of the neural network 102. Accordingly, each convolution unit is the hardware block that implements the convolution operations corresponding to a convolution layer of the neural network 102. Each activation unit is a hardware block that implements an activation operation after the convolution operation. Each pooling unit is a hardware block that implements pooling functions between the convolution layers. The convolution units 106, the activation units 108, and the pooling units 110 cooperate in generating prediction data 114 from the feature data 106.

In one embodiment, each convolution unit is a convolution accelerator. Each convolution unit performs convolution operations on feature data provided to the convolution unit. The feature data is generated from the feature data 106. The convolution operations at a convolution layer convolve the feature data with kernel data generated during the machine learning process for the neural network 102. The convolution operations result in feature data that is changed in accordance with the kernel data.

The data from the convolution unit is provided to an activation unit. The activation unit performs activation operations on the data from the convolution unit. The activation operation can include performing nonlinear operations on data values received from the convolution unit. One example of an activation operation is a rectified linear unit (ReLU) operation. Other types of activation operations can be utilized without departing from the scope of the present disclosure.

The pooling unit receives feature data from the activation unit. The pooling unit performs pooling operations on the feature data received from the activation unit. Pooling operations are performed on the feature data to prepare the feature data for the convolution operations of the next convolution layer. The pooling unit performs the pooling operations between convolution layers. The pooling unit is used to accelerate convolutional neural network operations. The pooling unit can perform max pooling operations, minimum pooling operations, average pooling operations, or other types of pooling operations.

The neural network 102 utilizes tensor data structures for the feature data. The input of each unit hardware accelerator may be an input tensor. The feature data 106 may be stored as a feature tensor. The feature tensor may be provided to the neural network 102 from the external memory 104. The output of each hardware accelerator 112 may be an output tensor with different data values than the input tensor. In one example, the convolution unit receives an input tensor and generates an output tensor. The activation unit receives, as an input tensor, the output tensor of the convolution unit and generates an output tensor. The pooling unit receives, as an input tensor, the output tensor of the activation unit and generates an output tensor. The output tensor of the pooling unit may be passed to the external memory 104.

Tensors are similar to matrices in that they include a plurality of rows and columns with data values in the various data fields. A convolution operation generates an output tensor of the same dimensions as the input tensor, though with different data values. An activation operation generates an output tensor of the same dimensions as the input tensor, though with different data values. A pooling operation generates an output tensor of reduced dimensions compared to the input tensor.

A pooling operation takes a portion, such as a pooling window, of a feature tensor and generates a pooled sub-tensor of reduced dimension compared to the pooling operation. Each data field in the pooled sub-tensor is generated by performing a particular type of mathematical operation on a plurality of data fields (such as taking the maximum value, the minimum value, or the average value from those data fields) from the feature tensor. The pooling operations are performed on each portion of the feature tensor. The various pooling sub-tensors are passed to the next convolution layer as the feature tensor for that convolution layer. Accordingly, pooling helps to reduce and arrange data for the next convolution operation.

Continuing with the example of an image sensor, the image sensor may output sensor data of a plurality of floating-point data values. The floating-point data values may utilize large amounts of memory or may otherwise be unwieldy or inefficient to process with the neural network 102. Accordingly, before the sensor data is arranged into an input tensor, the floating-point data values may undergo a quantization process. The quantization process converts each floating-point data value to a quantized data value. The quantized data value may have reduced numbers of bits compared to the floating-point data values, may be changed to integers, or may otherwise be changed in order to promote efficient processing by the neural network 102.

Various quantization formats can be utilized for the feature data 106. One possible quantization format is scale/offset format. Another possible quantization format is fixed point format. There may be various advantages to using either of these formats. Further details regarding these quantization formats are provided in relation to FIGS. 4A-4C. While the description and figures primarily describe scale/offset and fixed point quantization formats, other quantization formats can be utilized without departing from the scope of the present disclosure.

The stream engine 105 receives the feature data 106 from the external memory 104 and provides the feature data 106 to the stream switch 108. The stream switch 108 is a switch, or series of switches that directs the flow of data within the neural network 102. In general, when data is provided from one component of the neural network 102 to another component, the data passes through the stream switch between the components. Accordingly, a processing chain of the neural network 102 may be set up by configuring the stream switch 104 to provide data between components.

The internal storage 110 is configured to store data received from the external memory 104 so that the external memory 104 can be accessed fewer times. Accordingly, in one example, when feature data is received by the stream engine 105, the stream engine 105 passes the feature data to the internal storage 110 via the stream switch 108. The internal storage 110 then stores the data before the data is provided to a next component of the neural network 102.

In one example, the next component of the neural network may be a hardware accelerator 112 such as a convolution unit. The convolution unit receives the feature data and performs convolution operations by convolving the feature data with kernel data. The kernel data is generated during the machine learning process for the neural network 102. The convolution operations result in feature data that is changed in accordance with the kernel data. The new feature data is provided from one convolution unit 104 a next hardware accelerator 112.

In one example, the kernel data may correspond to a plurality of kernels. Each kernel may have the form of the matrix or tensor of a selected size. Each kernel operates on a portion of the tensor data. Often times, these portions of the tensor data overlap. This could result in reading data multiple times from the external memory 104.

As one example, each kernel may correspond to a 3×3 tensor or matrix. In a convolution sequence, a kernel may operate on a first 3×3 portion (3 columns and 3 rows) of the tensor data. The next kernel (or even the same kernel) may operate on a second 3×3 portion of the tensor data. Kernels may continue to operate on additional 3×3 portions of the tensor data until all of the convolution operations have been performed. The first portion of the tensor data may overlap with the second portion of the tensor data. For example, the second portion of the tensor data may be shifted one column to the right with respect to the first portion of the tensor data such that two columns of the first portion of the sensor data are included. When the final column the feature data is reached for a group of three rows, the next 3×3 portion may return to the first column and may be shifted downward one row. The shift between the portions may correspond to the stride. Various other schemes for convolving the feature data with kernel data can be utilized. Different kernel sizes can also be utilized.

Due to the overlapping nature of the convolution operations on the feature data 106 with various kernels, individual data values from the feature data 106 may be provided to the convolution accelerator many times. One possible solution is to read these individual data values multiple times from the external memory 104. However, this is both time-consuming and resource intensive. Accordingly, reading each data value of the feature data 106 from the external memory 104 multiple times can lead to serious drawbacks that in terms of the effectiveness and efficiency of the neural network 102.

The neural network 102 avoids the drawbacks of reading the same data multiple times from the external memory 104 by implementing the external storage 110 within the neural network 102. In particular, the feature data 106 may be provided in relatively large batches from the external memory 104 to the neural network 102. The stream engine 105 provides the batch of feature data to the internal storage 110 via the stream switch 105. The next hardware accelerator 112 (e.g., a convolution accelerator) can then receive the feature data 106 from the internal storage 110. Instead of reading the data values multiple times from the external memory 104, the hardware accelerator 112 can read data values from the internal storage 110. This can greatly reduce the number of times that the external memory 104 is accessed.

In one embodiment, the internal storage 110 not only stores feature data before providing the feature data to the hardware accelerator 112, the internal storage also rearranges the data when storing the data. For example, the internal storage 110 may include transformation and control circuitry that stores the feature data 106 with a write addressing pattern selected to promote the efficiency and providing the data to the next hardware accelerator 112. Rather than writing the data values sequentially in rows and columns of a memory array of the internal storage 110 in the order they are received from the external memory 104, the transformation and control circuitry of the internal storage 110 may store the data values in a nonsequential manner in the rows and columns of the memory array relative to the order in which they are received from the external memory 104. The write addressing pattern is selected based on how data is processed by the next hardware accelerator 112. This can greatly enhance the efficiency and providing data to the hardware accelerator 112 from the internal storage 110.

In one embodiment, the transformation and control circuitry of the internal storage 110 may also reads the feature data out to the next hardware accelerator 112 in accordance with a selected read address pattern. Rather than reading the data from rows and columns of a memory array of the internal storage 110 sequentially, the transformation and control circuitry of the internal storage 110 may read data values from the rows and columns of the memory array of the internal storage 110 in a nonsequential manner. The read addressing pattern can be selected based on how data is processed by the next hardware accelerator 112. Reading the data in this manner can greatly enhance the efficiency in providing data to the hardware accelerator 112 from the internal storage 110. As used herein, reading data with the internal storage 110 corresponds to outputting data from the internal storage 110 to another component of the neural network 102.

The rearrangement of the data via selective writing patterns and reading patterns can greatly enhance the efficiency of the neural network 102. In particular, the feature data can be provided to the hardware accelerator 112 with a pattern that enables rapid access and processing of the feature data. Continuing again with the example of a convolution operator, the feature data can be read in a manner selected to enable convolution operations with kernel data with great efficiency.

The internal storage 110 can operate as a smart cache. In particular, the transformation and control circuitry of the internal storage 110 can include a write transformation unit, a read transformation unit, and a control unit. These units can write data and read data with selected writing and reading address patterns to promote the efficiency of the neural network 112.

As used herein, the term “convolution unit” can be used interchangeably with “convolution circuit” or “convolution circuitry”. As used herein, the term “pooling unit” can be used interchangeably with “pooling circuit” or “pooling circuitry”. As used herein, the term “activation unit” can be used interchangeably with “activation circuit” or “activation circuitry”. As used herein, the term “requantization unit” can be used interchangeably with “requantization circuit” or “requantization circuitry”. This is because convolution units, the activation units, the pooling units, and the requantization units 112 are hardware circuits.

FIG. 2 is a functional flow diagram of a process 200 the can be utilized by a neural network 102, according to one embodiment. At 202, data is read from an external memory 104 via a stream engine 105 (not shown, see FIG. 1) and provided to the internal storage 110 via a stream switch 108 (not shown, see FIG. 1). At 204, the internal storage 110 writes the data with a write addressing pattern selected to enhance the efficiency of the neural network 102. At 204, internal storage 110 then reads (outputs) the data to a convolution accelerator 120 in accordance with a read address pattern selected to promote the efficiency of the neural network 102. The convolution accelerator 120 processes the feature data and provides the processed feature data to the pooling unit 122 via the stream switch. At 206, the pooling unit 122 performs pooling operations on the processed feature data. At 208, the pooling unit 110 provides the processed feature data to the external memory 104 via a stream engine 105 and the stream switch 108. The operation of the convolution accelerator 120 and the pooling unit 122 may correspond to a single layer of a CNN.

At 210, the processed feature data is read from the external memory into the internal storage 110 via the stream switch 108 and the stream engine 105, as described previously. The internal storage 110 may write the processed feature data to memory with an address pattern selected to promote the efficiency of the neural network 102. At 212, the internal storage 110 may read the processed feature data to a convolution accelerator 120 with a read pattern selected to promote the efficiency of the neural network 102. The convolution accelerator 120 processes the feature data. At 214 convolution accelerator 120 provides the now doubly processed feature data to the pooling unit 122 via the stream switch. The pooling unit 122 performs pooling operations on the feature data. The operations of convolution and pooling may correspond to a second convolution layer of the neural network.

The pooling unit 110 may provide the processed feature data to the fully connected layers. The fully connected layers may then output prediction data 114. Although only the convolution accelerator 120 and the pooling unit 122 are shown as hardware operators in the process 200, in practice, other hardware accelerators may be utilized instead of or in addition to the convolution accelerator 120 and the pooling unit 122. Additional convolution layers may also be utilized prior to passing data to the fully connected layers.

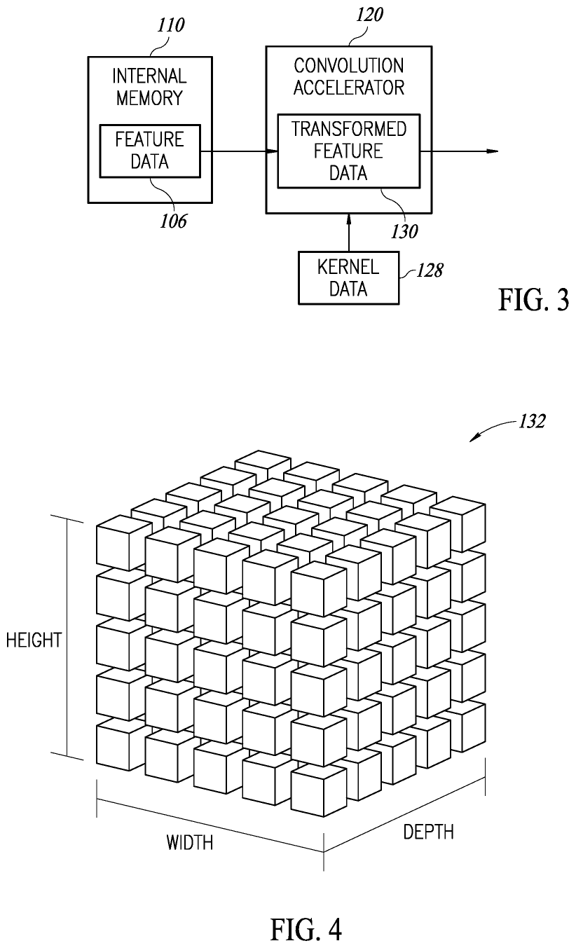

FIG. 3 illustrates a portion of a neural network 102, in accordance with some embodiments. Feature data 106 has been stored in the internal memory 110. The feature data 106 can be written to the internal memory 110 with a selected write addressing pattern. The feature data 106 can then be read to a convolution accelerator 120 with a selected read address pattern. The convolution accelerator 120 generates transformed feature data 130 (or processed feature data) by convolving the feature data 106 with kernel data 128. The reading of the feature data 106 to the convolution accelerator 120 is selected to enable the convolution accelerator 120 to perform a series of convolution operators with kernels from the kernel data 128 in a very efficient manner.

FIG. 4 is a representation of a feature tensor 132, according to one embodiment. The feature tensor 132 includes a plurality of blocks. Each of these blocks represents a data value. The tensor 132 includes height, width, and depth. While the feature tensor 132 of FIG. 4 illustrates a 5×5×5 tensor, in practice, the feature tensor 132 may include other height, width, and depth dimensions.

In one embodiment, during the various convolution, activation, pooling, and requantization operations, the feature tensor 132 is divided into batches. The feature tensor 132 may be batched by height, width, or depth. Convolution, activation, pooling, and requantization operations are performed on the batches from the feature tensor. Each batch may be considered a sub-tensor of the feature tensor 132.

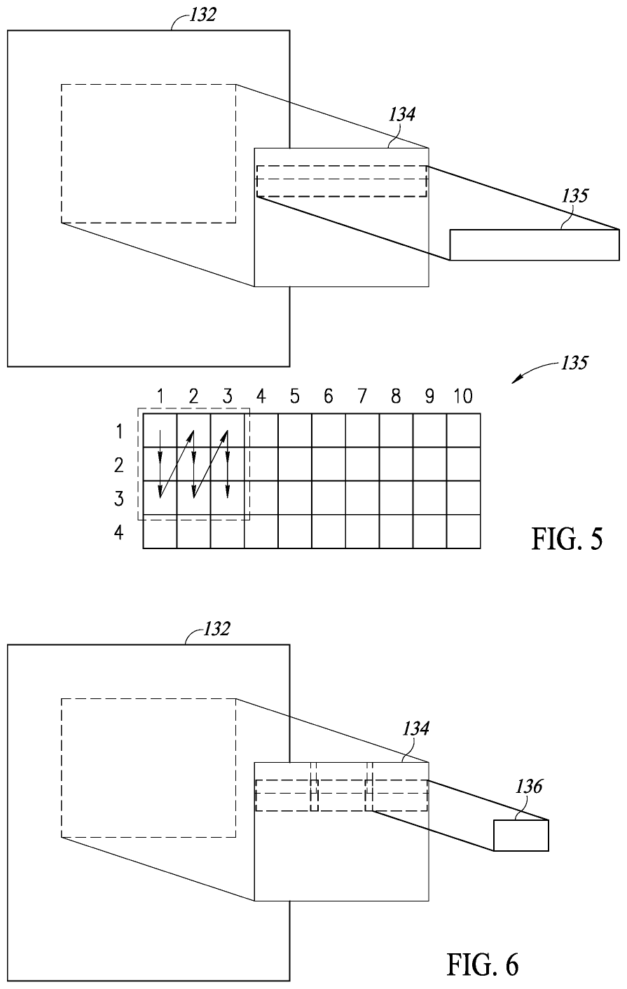

FIG. 5 illustrates a tensor 132 in accordance with one embodiment. In practice, the tensor 132 is read in batches 134 into the neural network 102. The batch 134 is stored in the internal storage 110. The batch 134 may then be read from the internal memory 110 in stripes 135. In the example of FIG. 5, the stripe has four rows and 10 columns. The number of columns of the stripe is the same as the number of columns of the batch 134. In practice, stripes 134 can have different dimensions or configurations without departing from the scope of the present disclosure.

FIG. 5 also illustrates a manner in which the stripe 135 may be read to the convolution unit 120. In particular, the stripe may be read from the internal storage 110 in columns, returning to the top after reading the bottom of the column. In the example FIG. 5, the dashed lines of the stripe illustrate a 3×3 portion of the tensor data that may be convolved with a 3×3 kernel by the convolution accelerator. A next 3×3 portion to be convolved with a next kernel may have a stride of one column to the right. Reading the data out of the internal storage 110 by columns in the manner shown can greatly improve the efficiency of the convolution operations with the kernels.

FIG. 6 illustrates a tensor 132 in accordance with one embodiment. In practice, the tensor 132 is read in batches 134 into the neural network 102. The batch 134 is stored in the internal storage 110. The batch 134 may then be read from the internal memory 110 in patches 136. Each patch may have a number of columns less than the number of columns in the batch 134.

FIG. 6 illustrates, via the dashed boxes, how a plurality of overlapping patches 136 may be drawn from a batch 134. The reading pattern of the data value of the patches 136 may be selected to help ensure efficient convolution operations with kernels of a convolution accelerator.

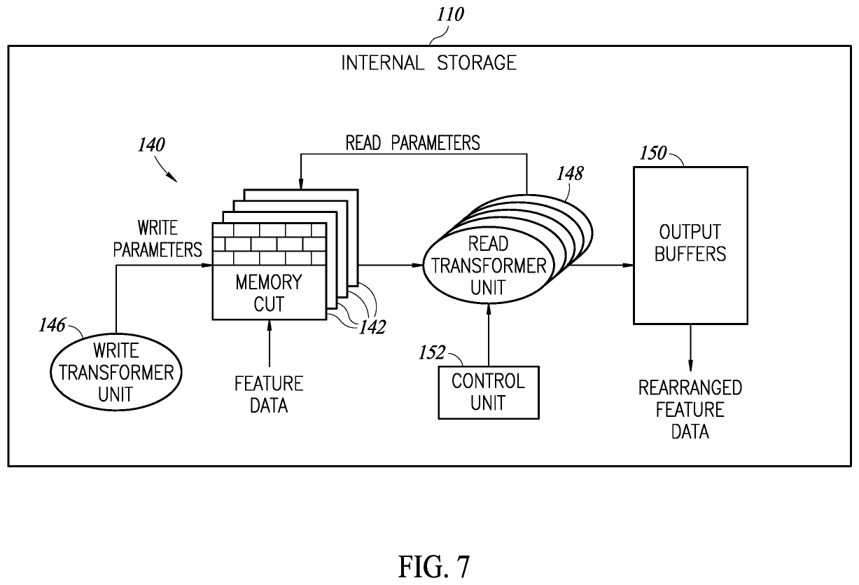

FIG. 7 is a block diagram of the internal storage 110, in accordance with some embodiments. The internal storage 110 includes a memory array 140. The memory array 140 may be arranged in rows and columns of memory cells. The memory array 140 may be divided into a plurality of memory cuts 142. Each memory cut 142 may have its own write ports and read ports. In one embodiment, each memory cut 142 may be associated with a particular hardware accelerator 112 of the neural network 102. In one embodiment, multiple cuts may be associated with a single hardware accelerator 112. Each memory cut 142 may include a plurality of memory cells arranged in rows and columns. The internal storage 110 may include logic around the memory array 140 such as pointers, enablers, etc.

In one embodiment, the memory array 140 is a static random access memory (SRAM) array. Other types of memory can be utilized in the memory array 140 without departing from the scope of the present disclosure. One example, the memory array 140 is 1024×120 memory cells, corresponding to 16 kB, though other sizes can be utilized without departing from the scope of the present disclosure.

The internal storage 110 includes a write transformer unit 146. When data is passed to the internal storage 110, the write transformer unit 146 may write the feature data into the memory 140 in accordance with a write address pattern selected to enable efficient operation on the feature data by a next hardware accelerator 112. The internal storage 110 may include configuration registers that control the function of the write transformer unit 146.

The internal storage 110 includes a read transformer unit 148 and a control unit 152. The control unit 152 controls the operation of the read transformer units 148. The read transformer unit reads data from the memory 140 in accordance with read parameters. The read parameters are provided by the control unit 152. The read parameters are selected as a pattern of addresses by which data will be read from the memory 140 to the output buffers 150. The feature data can be passed as rearranged feature data from the output buffers 150 of the internal storage 110 to a hardware accelerator 112.

The read transformer unit 148 may work with multiple memory cuts 142. This can allow having both more data to be served to the following hardware accelerators 112 and to dedicate different memory cuts 142 to different hardware accelerators 112. The solution can consider a selection method among the different memory cuts 142, choosing which one to address to retrieve the following data given the unit to which the data is to be sent. The memory cuts 142 can have the same or different numbers of rows and columns. The read transformer unit 148 can use each of the memory cuts 142 by knowing their sizes.

The control unit 152 may work as an interface between the memory 140 and the read transformer unit 148. The control unit may generate write addresses, read addresses, and may determine that the minimum amount of data has been received to begin reading data out to the next hardware accelerator 112. The control unit may take into account dimensions of the tensor in the dimensions of stripes and patches.

In one embodiment, once a selected minimum amount of data has been written to the memory 140, the read transformer unit 148 can begin to read data to a next hardware accelerator 112. Data can be reorganized while reading the data due to the selected read addressing pattern utilized by the read transformer unit 148.

In one embodiment, the write transformer unit 146 can transform feature data 146 and can make the feature data suitable to be written in the memory 140. For example, if each data value of the feature data is 32 bits, the write transformer unit 146 may reduce the number of bits in each data value to 24 bits by discarding eight bits from each data value.

The internal storage 110 may be utilized in connection with convolutional neural network architectures in order to correctly arrange, reorganize and transform the data to reduce the execution time and exploit data usage in this kind of application. However, the internal storage 110 is not limited to this framework and could be used in every architecture which performs the management of data and its manipulation in order to simplify the computations.

The internal storage 110 may be primarily (but not only) utilized to prepare the data for the following operations in order to have them ready to be fed to a hardware accelerator. The reorganization of data may follow methodologies capable of exploiting data locality or data organization to obtain faster and more compact operations, hence reducing execution times, number of epochs in the computation and overall energy consumption.

In one embodiment, the data arrive in packets of n bits, specified by the architecture connections and could be then packed, reorganized and transformed to obtain the benefits described herein. The local storage 110 provides operation modes dedicated to obtain a solution for memory efficiency problems and to provide the management among the different memory units in order to coordinate them and correctly format the data to be processed by the different units of the architecture and optimize its energy consumption over the entire computation.

The internal storage 110 may utilize nested loop processes for convolutional neural networks. In this scenario the internal storage may exploit hardware and software approaches for im2col, im2row transforms and in general re-layout strategies for the input tensor to obtain better data utilization. Data may first organized offline by a compiler in a way that some advantage could be exploited from the way the data are stored and/or retrieved. This may provide easier memory access (both for storage and retrieval of the data) and/or easier organization and development of the calculations needed (for convolutions or other types of operations).

The internal storage 110 may utilize the write transformer unit 146 and the read transformer unit 148 to correctly write/read to/from the memory unit. These units may be utilized to according to the indication given by the compiler, since in this way it would be possible to store and retrieve the data not only from a time perspective, but also from spatial one (both for the kernels and the features). The reading and the writing processes may utilize a nested loops approach, exploiting several parameters to organize the read/write of the data.

This hardware solution may also follow this kind of approach considering several parameters in the memory management and exploiting them to provide both efficiency and flexibility through different memory operations, in order to correctly exploit the advantages given from the data reshaped by the compiler. Memory ports could be single or multiple, given the number of units sharing the memory itself in the design. In the former case every unit could have its own dedicated memory cut 142. In the latter case more management of the memory could be utilized but higher flexibility of the same could be considered and sub partitions of it could be considered at the start of a new epoch.

Read and write operations can also follow a certain scheduling and provide some synchronization, handshaking or/and granting mechanism to correctly provide the data transformation and output the correct data avoiding issues. Therefore, also the memory cuts 142 can be aligned to the hardware units needs and hence to the elaboration ones providing a scheduler for the contemporary access to the memory of more than one unit, while using a shared memory approach.

Moreover, the definition of the size and dimensions of the different memory cuts 142 may be designed and specified in order to be able to manage the transformed data and to store and provide it for the different nested loop solution approaches in order to make the unit reusable for different neural network models. The design may also provide some customized memory cuts for specialized operations in the case of using convolutional neural network models that use well-known read/write patterns. The design of the internal storage 110 may also provide smart addressing modes to correctly address multiple cuts of memory at the same time, just on the addressing pattern, data or both, being also capable of reducing the time and the energy to develop the operations for the different units.

Further details regarding neural networks and machine learning applications can be found in T. Chen, Z. Du, N. Sun, J. Wang, C. Wu, Y. Chen, and O. Temam, “DianNao: a small-footprint high-throughput accelerator for ubiquitous machine-learning,” in Proc. 19th Int'l Conf. on Architectural Support for Programming Languages and Operating Systems. ACM, 2014, pp. 269-284, Y. Chen, T. Luo, S. Liu, S. Zhang, L. He, J. Wang, L. Li. T. Chen, Z. Xu, N. Sun et al., “DaDianNao: a machine-learning supercomputer,” in 47th Annual IEEE/ACM Int'l Symp. on Microarchitecture (MICRO), IEEE, 2014, pp. 609-622, M. Peemen, A. A. Setio, B. Mesman, and H. Corporaal, “Memorycentric accelerator design for convolutional neural networks,” in 31^{st} Int'l Conf. on Computer Design (ICCD) IEEE, 2013, pp. 13-19, and J. Jin, V. Gokhale, A. Dundar, B. Krishnamurthy, B. Martini, and E. Culurciello, “An efficient implementation of deep convolutional neural networks on a mobile coprocessor,” in IEEE 57th Int'l Midwest Symp. on Circuits and Systems (MWSCAS), IEEE, 2014, pp. 133-136, each of which is incorporated herein by reference in their entireties.

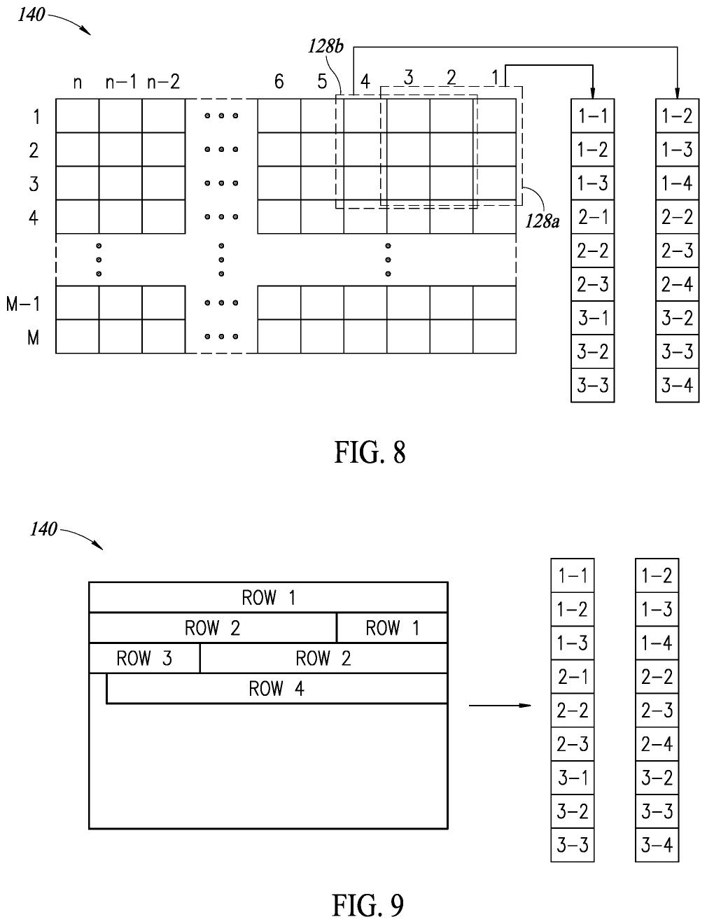

FIG. 8 is an illustration of a memory 140 of an internal storage 110 of a neural network 102, according to one embodiment. The memory 140 of FIG. 8 is one example of a memory 140 of FIG. 7. The memory 140 is arranged in n rows and m columns.

FIG. 8 also illustrates the portion of data on which a first kernel 128a will operate when the data is passed to a convolution operator. The internal storage 110 reads out the data corresponding to the first kernel 128a in columns in order to facilitate convolution operation of the kernel 128a on the selected portion of the feature data in the memory 140, in one embodiment. The first portion includes data from rows 1, 2, 3 and from columns 1, 2, 3.

In one embodiment, the data for the first kernel 128a is written to the output buffer of the internal storage 120 by rows in which the data values of the first row (1-1, 1-2, and 1-3) are first read, then the data values in the second row (2-1, 2-2, and 2-3) are read, and finally the data values of the third row (3-1, 3-2, and 3-3) are read. This reading pattern may greatly facilitate convolution operations to be performed in accordance with the kernels of the kernel data. Other reading patterns can be utilized without departing from the scope of the present disclosure

FIG. 8 also illustrates the portion of data on which a second kernel 128b will operate when the data is passed to a convolution operator. In one embodiment, the internal storage 110 reads out the data corresponding to the first kernel 128b in rows in order to facilitate convolution operation of the kernel 128b on the selected portion of the feature data in the memory 140. For example, the data to be convolved with the second kernel 128b are read by rows in which the data values of the first row (1-2, 1-3, and 1-4) are first read, then the data values in the second row (2-2, 2-3, and 2-4) are read, and finally the data values of the third row (3-2, 3-3, and 3-4) are read. This reading pattern may greatly facilitate convolution operations to be performed in accordance with the kernels of the kernel data. Other reading patterns can be utilized without departing from the scope of the present disclosure as can be seen, sixth data values to be convolved with the first kernel 128a overlap with the data values to be convolved with the second kernel 128b. Because the data are initially stored in the internal storage 110, the repeated data values can be read from the internal storage 110 rather than repeatedly accessing the external storage 104.

FIG. 9 is an illustration of a memory 140 of an internal storage 110 of a neural network 102, according to one embodiment. FIG. 9 illustrates how rows of tensor data may be larger than rows of the memory 140. Accordingly, a single row of tensor data may occupy portions of two rows in the memory 140. The write transformation unit 146 and the read transformation unit 148 can help ensure that when data is read from the memory 140 to the convolution operator 120, the addresses are selected to ensure that the data is read in a manner that facilitates convolution operations with the kernels.

The internal storage 110 can determine when a next data value to be convolved with a next kernel is found in a same row of the physical memory of the memory array 140 or in a different row of physical memory of the memory array 140. Accordingly, the writing and reading of data can be accomplished with patterns of physical addresses that promote the efficiency and providing the data to a next hardware accelerator 112.

In one embodiment, in accordance with the example shown in FIG. 9, for a first patch (to be convolved with a first kernel) the internal storage 110 reads the first three data values (1-1, 1-2, and 1-3) of the first row of the tensor data, then the first three data values (2-1, 2-2, and 2-3) of the second row of the tensor data, then the first three data values (3-1, 3-2, and 3-3) of the of the tensor data. Because the rows of the tensor data are different than the physical rows of the memory 140 of the internal storage, the internal storage intelligently reads the correct sequence of data values in spite of the difference in size of rows between the original tensor data and the memory array 140. After reading the first patch, a second patch can be read by shifting to the right one column of tensor data.

Accordingly, the internal storage may pay particular attention when picking data for the same row over different lines (address increase +1, with possibly no increase when shifting to the next row). Knowing the row and column offsets, the internal storage 110 can intelligently know when to change the address when shifting from one pixel to another one change the address when shifting from one pixel to a “contiguous” one.

Knowing the height offset the internal storage 110 can know how many locations to skip before the next data when changing row in the considered patch, together with the vertical stride Hstride. These parameters may also help, combined with the horizontal stride Wstride and Hstride to move the vertical and horizontal pointers of the memory to the starting point of the next patch to be considered.

The internal storage 110 implements a scheme tackling the issue from both a software aspect and an ASIC hardware aspect. This is fit to be used for different neural network models in a programmable fashion, in order to obtain solutions for the different needs in the different scenarios. This may also improve power performance and overall computation speed for ASIC implementations.

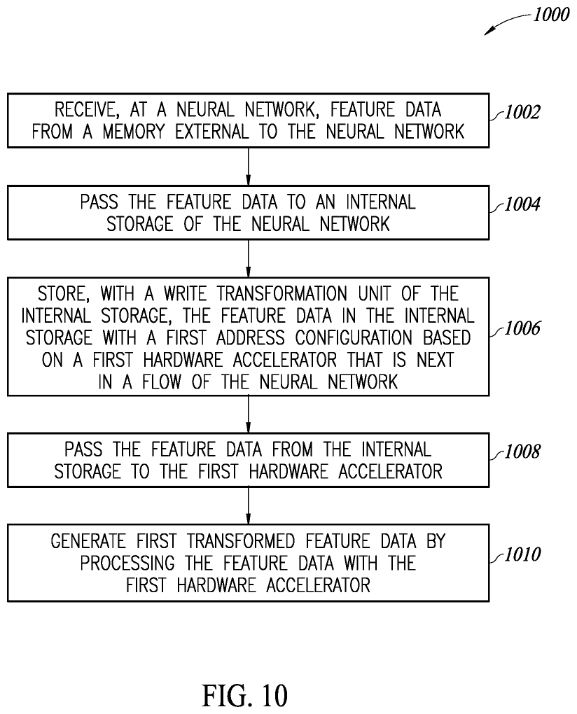

FIG. 10 is a flow diagram of a method 1000, in accordance with one embodiment. The method 1000 may utilize components, systems, and processes described in relation to FIGS. 1-9. At 1002, the method 1000 includes receiving, at a neural network, feature data from a memory external to the neural network. At 1004, the method 1000 includes passing the feature data to an internal storage of the neural network. At 1006, the method 1000 includes storing, with a write transformation unit of the internal storage, the feature data in the internal storage with a first address configuration based on a first hardware accelerator that is next in a flow of the neural network. At 1008, the method 1000 includes passing the feature data from the internal storage to the first hardware accelerator. At 1020, the method 1000 includes generating first transformed feature data by processing the feature data with the first hardware accelerator.

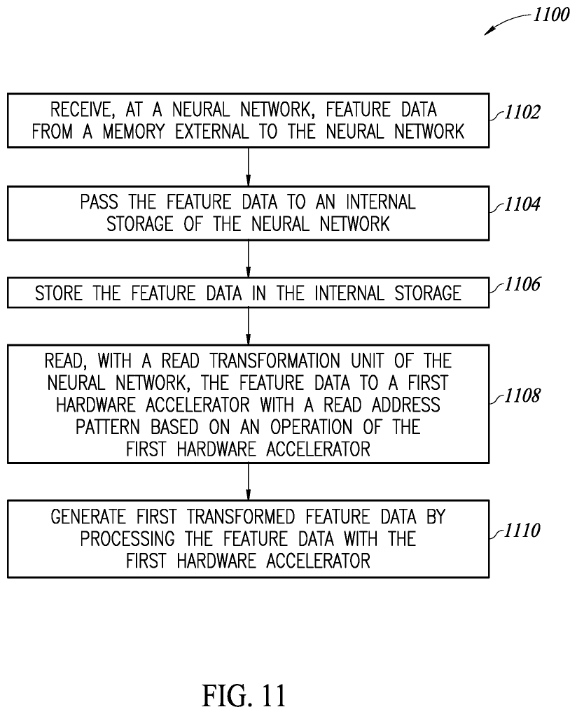

FIG. 11 is a flow diagram of a method 1100, in accordance with one embodiment. The method 1100 may utilize components, systems, and processes described in relation to FIGS. 1-9. At 1102, the method 1100 includes receiving, at a neural network, feature data from a memory external to the neural network. At 1104, the method 1100 includes passing the feature data to an internal storage of the neural network. At 1106, the method 1100 includes storing the feature data in the internal storage. At 1108, the method 1100 includes reading, with a read transformation unit of the neural network, the feature data to a first hardware accelerator with a read address pattern based on an operation of the first hardware accelerator. At 1110, the method 1100 includes generating first transformed feature data by processing the feature data with the first hardware accelerator.

In one embodiment, a method includes receiving, at a neural network, feature data from a memory external to the neural network, passing the feature data to an internal storage of the neural network, and storing, with a write transformation unit of the internal storage, the feature data in the internal storage with a first address configuration based on a first hardware accelerator that is next in a flow of the neural network. The method includes passing the feature data from the internal storage to the first hardware accelerator and generating first transformed feature data by processing the feature data with the first hardware accelerator.

In one embodiment, a method includes receiving, at a neural network, feature data from a memory external to the neural network and passing the feature data to an internal storage of the neural network. The method includes storing the feature data in the internal storage and reading, with a read transformation unit of the neural network, the feature data to a first hardware accelerator with a read address pattern based on an operation of the first hardware accelerator. The method includes generating first transformed feature data by processing the feature data with the first hardware accelerator.

In one embodiment, a device includes a neural network. The neural network includes a stream engine configured to receive feature data from a memory external to the neural network, a hardware accelerator, and an internal storage configured to receive the feature data from the stream engine. The internal storage includes a write transformation unit configured to write the feature data into the internal storage with a write address pattern based on a configuration of the hardware accelerator. The internal storage includes a read transformation unit configured to read the feature data to the hardware accelerator with a read address pattern based on the configuration of the hardware accelerator, the hardware accelerator configured to receive the feature data from the internal storage, to process the feature data to generate transformed feature data.

Some embodiments may take the form of or comprise computer program products. For example, according to one embodiment there is provided a computer readable medium comprising a computer program adapted to perform one or more of the methods or functions described above. The medium may be a physical storage medium, such as for example a Read Only Memory (ROM) chip, or a disk such as a Digital Versatile Disk (DVD-ROM), Compact Disk (CD-ROM), a hard disk, a memory, a network, or a portable media article to be read by an appropriate drive or via an appropriate connection, including as encoded in one or more barcodes or other related codes stored on one or more such computer-readable mediums and being readable by an appropriate reader device.

Furthermore, in some embodiments, some or all of the methods and/or functionality may be implemented or provided in other manners, such as at least partially in firmware and/or hardware, including, but not limited to, one or more application-specific integrated circuits (ASICs), digital signal processors, discrete circuitry, logic gates, standard integrated circuits, controllers (e.g., by executing appropriate instructions, and including microcontrollers and/or embedded controllers), field-programmable gate arrays (FPGAs), complex programmable logic devices (CPLDs), etc., as well as devices that employ RFID technology, and various combinations thereof.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, comprising:
receiving, at a neural network, feature data from a memory external to the neural network;
passing the feature data to an internal storage of the neural network;
storing, with a write transformation unit of the internal storage, the feature data in the internal storage with a first address configuration based on a first hardware accelerator that is next in a flow of the neural network;
passing the feature data from the internal storage to the first hardware accelerator; and
generating first transformed feature data by processing the feature data with the first hardware accelerator.

2. The method of claim 1, comprising passing the first transformed feature data to the memory.

3. The method of claim 2, comprising:
receiving, at the neural network, the first transformed feature data from the memory;
passing the first transformed feature data to the internal storage;
storing, with the write transformation unit of the internal storage, the transformed feature data in the internal storage with a second address configuration based on a second hardware accelerator that is next in the flow of the neural network;
passing the transformed feature data from the internal storage to the second hardware accelerator; and
generating second transformed feature data by processing the first transformed feature data with the second hardware accelerator.

4. The method of claim 1, wherein the first hardware accelerator is a convolution accelerator.

5. The method of claim 4, wherein the first address configuration is based on a kernel size associated with the convolution accelerator.

6. The method of claim 4, wherein passing the transformed feature data includes reading, with a read transformation unit the feature data from the internal storage with a read address pattern based on the first hardware accelerator.

7. The method of claim 6, wherein the read address patter is based on a kernel size associated with the convolution accelerator.

8. The method of claim 5, comprising:
receiving the feature data in rows with the internal storage from the memory; and
reading the data from internal storage in columns with the read transformation unit.

9. The method of claim 5, comprising controlling the read transformation unit with a control unit of the internal storage.

10. The method of claim 1, comprising controlling the write transformation unit with configuration registers of the neural network.

11. A method, comprising:
receiving, at a neural network, feature data from a memory external to the neural network;
passing the feature data to an internal storage of the neural network;
storing the feature data in the internal storage;
reading, with a read transformation unit of the neural network, the feature data to a first hardware accelerator with a read address pattern based on an operation of the first hardware accelerator;
generating first transformed feature data by processing the feature data with the first hardware accelerator.

12. The method of claim 11, wherein the first hardware accelerator is a convolution accelerator.

13. The method of claim 12, wherein the read address pattern is based on a kernel size of the first hardware accelerator.

14. The method of claim 13, wherein the feature data is a feature tensor.

15. The method of claim 11, comprising:
determining, with a control unit of the internal storage, whether a sufficient amount of the feature data has been received at the internal storage; and
reading the feature data from the internal storage to the first hardware accelerator only if the control unit determines that a sufficient amount of the feature data has been received at the internal storage.

16. The method of claim 11, comprising passing the first transformed feature data to the memory.

17. The method of claim 16, comprising:
receiving, at the neural network, the first transformed feature data from the memory;
passing the first transformed feature data to the internal storage;
storing, with a write transformation unit of the internal storage, the transformed feature data in the internal storage with an address configuration based on a second hardware accelerator that is next in a flow of the neural network;
passing the first transformed feature data from the internal storage to the second hardware accelerator; and
generating second transformed feature data by processing the first transformed feature data with the second hardware accelerator.

18. A device comprising a neural network, the neural network including:
a stream engine configured to receive feature data from a memory external to the neural network;
a hardware accelerator; and
an internal storage configured to receive the feature data from the stream engine, the internal storage including:
a write transformation unit configured to write the feature data into the internal storage with a write address pattern based on a configuration of the hardware accelerator; and
a read transformation unit configured to read the feature data to the hardware accelerator with a read address pattern based on the configuration of the hardware accelerator, the hardware accelerator configured to receive the feature data from the internal storage and to process the feature data to generate transformed feature data.

19. The device of claim 18, wherein the internal storage includes a control unit configured to control the read transformation unit.

20. The device of claim 18, wherein the neural network is a convolutional neural network.
